(19) United States
(12) Patent Application Publication
(10) Pub. No.: US 2026/0217168 A1
(43) Pub. Date: Jul. 30, 2026

(54) VEHICLE CHASSIS FORMED OF A HYDROGEN TANK MADE OF COMPOSITES HAVING AN ANTI-SUBMARINING BUMP

(71) Applicant: AMPERE S.A.S., Boulogne Billancourt (FR)

(72) Inventors: Panagiotis CHRISTOU, Guyancourt (FR); Jérémi GOBRECHT, Guyancourt (FR); Laurent GRENIER, Guyancourt (FR); Kamel MOUSSI, Guyancourt (FR)

(73) Assignee: AMPERE S.A.S., Boulogne Billancourt (FR)

(21) Appl. No.: 19/141,871

(22) PCT Filed: Dec. 19, 2023
(86) PCT No.: PCT/EP2023/086552

§ 371 Date: Jun. 20, 2025

(30) Foreign Application Priority Data
Dec. 21, 2022 (FR) FR2214080

(51) Int. Cl. B60N 2/427; B60K 15/03; B60K 15/063; B60N 2/015; B60R 22/22; B62D 21/16; B62D 25/20

(52) U.S. Cl. CPC B60N 2/42745; B60K 15/063; B60N 2/015; B60R 22/22; B62D 21/16; B62D 25/20; B60K 2015/03315; B60K 2015/0633

(57) ABSTRACT

A chassis for a vehicle body includes a floor formed by a hydrogen tank made of composite material. The floor includes an anti-submarining bump.

### TECHNICAL FIELD

The present invention relates to the structure of hydrogen-powered vehicles having a single hydrogen tank, in particular motor vehicles.

The present invention aims to constitute a chassis of such a vehicle, which is structurally formed in part by the hydrogen tank, and which in particular incorporates an anti-submarining hump.

### PRIOR ART

Vehicles, in particular motor vehicles, systematically have anti-submarining humps for restraining the pelvis of the passengers in the event of an accident, so that they do not pass under the strap of their seatbelts that pass over their thighs and that are each fastened by two lateral buckles fastened to the floor on each side of each passenger.

The anti-submarining hump is formed either by a bulge in the sheet metalwork of the floor, or by a solid bar that is welded or bolted to the floor, so as to stop the forward movement of the pelvis of the passengers, with flexibility initially, by deformation at the moment of the impact between the thighs of the passenger and the anti-submarining hump, then suddenly with a very limited deformation in order to stop the displacement of the pelvis of the passengers.

These two deformation phases are programmed so as to accommodate the passengers satisfactorily, i.e. without an excessively sudden stop, for maximum force storage.

In known hydrogen vehicle chassis, the anti-submarining hump of the spaces for the rear passengers is fixed because it is formed of tubes or constituted by the sheet metalwork of the floor of the vehicle, and this makes the vehicle heavier and increases the number of pieces, in particular the sheet metalwork pieces and the side members.

### SUMMARY OF THE INVENTION

The invention relates to a vehicle of which the floor of the chassis of the body is replaced by the hydrogen tank itself, which therefore does away with structural elements connected to the floor and interface pieces.

The invention proposes a hydrogen engine vehicle chassis capable of combining advantages of lightness, simplicity and reliability for the implementation thereof.

In view of the foregoing, one subject of the invention is a chassis for a vehicle body, having a floor formed by a hydrogen tank made of composite material, the floor having an anti-submarining hump.

Preferably, the anti-submarining hump is formed by a bulge in the floor, so as to damp and then stop the movement of the pelvis of passengers of the vehicle sitting on a rear bench seat of the vehicle that is coupled to the chassis, with damping initially, by a first deformation at the moment of the impact between the thighs of the passenger and the anti-submarining hump, then suddenly with a second deformation that is more limited than the first in order to stop the displacement of the pelvis of said passengers.

For example, the hydrogen tank comprises a composite material.

Advantageously, the anti-submarining hump incorporates fasteners for a rear bench seat of the vehicle.

According to one embodiment, the fasteners have vehicle seatbelt buckles, said buckles being fastened to the tank.

In one embodiment, the anti-submarining hump incorporates an articulation for a backrest of a rear bench seat of the vehicle, said articulation being designed to be able to position said seat in a substantially vertical position.

Advantageously, the articulation is fastened to the tank.

The chassis can also provide that the anti-submarining hump is slightly smaller opposite a location intended for the pelvises of the passengers of the vehicle on a rear bench seat of the vehicle, and that between a rear end of the tank and the anti-submarining hump of the tank there is disposed a plastic casing also covering the floor, and that a thickness of rigid foam is interposed between said casing and the tank.

The invention also relates to a vehicle body having such a chassis, and to a vehicle having such a vehicle body.

### BRIEF DESCRIPTION OF THE DRAWINGS

The invention will be understood better from the detailed examination of an embodiment given by way of non-limiting example and illustrated in the appended drawings, in which:

FIG. 1 shows the chassis according to the invention, in a lateral sectional view at the center of the space of the right rear passenger of the rear bench seat of the vehicle.

FIG. 2 shows the chassis in a perspective view.

### DETAILED DESCRIPTION

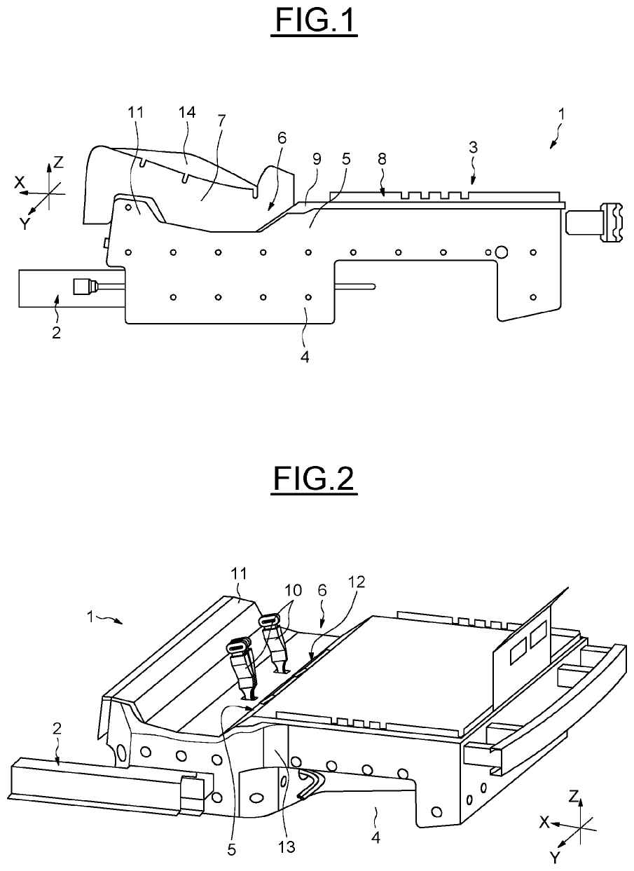

FIG. 1 illustrates the vehicle chassis 1 according to the invention, which is intended for a vehicle having a hydrogen engine, in particular a motor vehicle.

In all the figures, the direct orthonormal reference frame XYZ conventionally denotes the front-rear longitudinal direction of the vehicle by the axis X, a left-right lateral direction for a passenger of the vehicle by the axis Y, and the vertical upward direction by the axis Z.

The chassis 1 is intended to be mounted on a vehicle body 2, in particular of a vehicle transporting passengers.

The chassis 1 has a floor 3 making up the bottom wall of the vehicle and formed by a hydrogen tank made of composite material 4.

The tank 4 is, for example, a tank such as that described in patent application FR2888915, comprising an internal chamber for storing hydrogen formed by a plurality of opposite walls that can be connected internally by shafts allowing the mechanical reinforcement of the chamber.

The floor 3 has an anti-submarining hump 5, which is intended to restrain the pelvis of the passengers in the event of an accident, so that they do not pass under the strap of the seatbelts that pass over their thighs and that are each fastened by two lateral buckles fastened to the floor on each side of each passenger.

The anti-submarining hump 5 is for example formed by a bulge in the floor 3 so as to damp and then stop the movement of the pelvis of passengers of the vehicle sitting on a rear bench seat of the vehicle 7 that is coupled to the chassis 1.

Contrary to the prior art in which the anti-submarining hump 5 is formed by a rigid bar that is welded or bolted to the floor 3, the anti-submarining hump 5 incorporated in the tank 4 does not require any added piece and simplifies the production and maintenance of the vehicle.

The anti-submarining hump 5 makes it possible to stop the movement of the pelvis of the passengers with damping initially, by a first deformation at the moment of the impact between the thighs of the passenger and the anti-submarining hump 5, then suddenly with a second deformation that is more limited than the first in order to completely stop the displacement of the pelvis of said passengers.

For example, the hydrogen tank 4 comprises a composite material.

This material allows sufficient resistance to the pressure differences caused by the storage of the hydrogen, while at the same time making it possible for the tank 4 to be produced in a shape best suited to the vehicle for the structuring and of the chassis 1 and the incorporation thereof into the body of the vehicle.

The tank 4 can therefore have hollowed-out parts 6, and this makes it possible to create a shape of the underside of the fixed rear bench of the vehicle that is able to be filled with foam for the padding 14 of the seat and/or for the damping of the impacts from below.

The tank 4 may also have a part that is bulged to create the anti-submarining hump 5 so as to restrain the pelvis of the passengers, by stopping the forward translational movement of the vehicle if the impact is on the front.

A rear end 11 may also have a hump designed for the same restraining of the pelvis of the passengers in the rear direction X.

Advantageously, the anti-submarining hump 5 incorporates fasteners 10 for a rear bench seat of the vehicle 7.

As illustrated in FIG. 2, the fasteners 10 may have vehicle seatbelt buckles 10, said buckles 10 being fastened to the tank 4.

In one embodiment, the anti-submarining hump 5 incorporates an articulation 12 for a backrest of a rear bench seat of the vehicle 7, said articulation 12 being designed to be able to position said seat 7 in a substantially vertical position.

Advantageously, the articulation 12 is fastened to the tank 4.

The chassis can also provide that the anti-submarining hump 5 is slightly smaller, in particular along the lateral axis Y, opposite a location intended for the pelvises of the passengers of the vehicle on a rear bench seat of the vehicle 7.

Thus, the anti-submarining hump 5, formed by the tank 4, is slightly smaller opposite the pelvis of the passengers, and this makes it deformable by virtue of the narrowing 13 and gives it a damping effect initially in the event of an impact, before being more rigid.

Furthermore, between a rear end 11 of the tank 4 and the anti-submarining hump 5 of the tank 4 there is disposed a plastic casing 8 also covering the floor 3, and a thickness of rigid foam 9 is interposed between said casing 8 and the tank 4.

Between the regulatory points of the anti-submarining hump 5 and the hump of the tank 4, for example the end hump 11, a plastic casing is placed so as to form a lining covering the floor 3, and the intermediate foam 9 between said casing 8 and the tank 4 is selected for its hardness.

A particularly light chassis 1 is thus obtained, which minimizes the sheet metalwork to be welded for the assembly thereof, and therefore shortens the time for the mounting thereof on a vehicle, and which is such that in the event of an accident, the pelvis of the passengers sitting on the rear bench forming the seat 7 for these passengers will crush a padding 14 of said seat 7, which will come into contact with the plastic casing 8, which will itself crush the hard foam 9 against the anti-submarining hump 5 formed in the particularly rigid composite of the hydrogen tank 4, and this makes it possible to keep the passengers bound to this rigid structure, while at the same time allowing the belt buckles and the articulation of the rear bench backrest to be fastened directly to the tank 4.

1-10. (canceled)

11. A chassis for a vehicle body, comprising:
a floor formed by a hydrogen tank, the floor having an anti-submarining hump.

12. The chassis as claimed in claim 11, wherein the anti-submarining hump is formed by a bulge in the floor so as to damp and then stop movement of a pelvis of a passenger of the vehicle sitting on a rear bench seat of the vehicle that is coupled to the chassis, with damping initially, by a first deformation at a moment of an impact between thighs of the passenger and the anti-submarining hump, then suddenly with a second deformation that is more limited than the first in order to stop the movement of the pelvis of said passenger.

13. The chassis as claimed in claim 11, wherein the hydrogen tank comprises a composite material.

14. The chassis as claimed in claim 11, wherein the anti-submarining hump incorporates fasteners for a rear bench seat of the vehicle.

15. The chassis as claimed in claim 14, wherein the fasteners have vehicle seatbelt buckles, said buckles being fastened to the tank.

16. The chassis as claimed in claim 11, wherein the anti-submarining hump incorporates an articulation for a backrest of a rear bench seat of the vehicle, said articulation being configured to position said seat in a substantially vertical position.

17. The chassis as claimed in claim 16, wherein the articulation is fastened to the tank.

18. The chassis as claimed in claim 12, wherein the anti-submarining hump is slightly smaller opposite a location configured for the pelvis of the passenger of the vehicle on the seat, and between a rear end of the tank and the anti-submarining hump of the tank there is disposed a plastic casing also covering the floor, and a thickness of rigid foam is interposed between said casing and the tank.

19. A vehicle body, comprising:
the chassis as claimed in claim 11.

20. A vehicle, comprising:
the vehicle body as claimed in claim 19.
